(19) United States
(12) Patent Application Publication
(10) Pub. No.: US 2012/0130867 A1
(43) Pub. Date: May 24, 2012

(54) COMMODITY INFORMATION PROVIDING SYSTEM AND COMMODITY INFORMATION PROVIDING METHOD

(75) Inventors: Tsunehiro Motegi, Tokyo (JP); Mahina Nakamura, Tokyo (JP); Maki Sato, Kanagawa (JP); Yumiko Okuma, Tokyo (JP)

(73) Assignee: TOSHIBA TEC KABUSHIKI KAISHA, Tokyo (JP)

(21) Appl. No.: 13/297,432

(22) Filed: Nov. 16, 2011

(30) Foreign Application Priority Data
Nov. 18, 2010 (JP) 2010-258321

(51) Int. Cl. G06Q 10/08

(52) U.S. Cl. 705/28

(57) ABSTRACT

According to one embodiment, a commodity information providing system includes: a commodity-data acquiring section configured to acquire, on the basis of location data indicating a location of an information terminal including a display screen and commodity data associated with a place or an area, commodity data that is provided to or can be provided to the information terminal; and a display-data generating section configured to generate display data for displaying, on the display screen of the information terminal, information concerning a commodity corresponding to the commodity data acquired by the commodity-data acquiring section.

### CROSS-REFERENCE TO RELATED APPLICATION

This application is based upon and claims the benefit of priority from the prior Japanese Patent Application No. 2010-258321 field on Nov. 18, 2010, the entire contents of which are incorporated herein by reference.

### FIELD

Embodiments described herein relate generally to a commodity information providing system and a commodity information providing method.

### BACKGROUND

In the past, there is known a system that displays a coordinate image obtained by combining images of commodities such as clothing and enables a customer to easily consider coordinates.

The system of this type is demanded to be a system more convenient for a user while further facilitating sales of commodities in stores.

### DESCRIPTION OF THE DRAWINGS

FIG. 1 is a schematic diagram of an example of a schematic configuration of a commodity information providing system according to an embodiment;

FIG. 2 is a schematic diagram of an example of a shopping mall where the commodity information providing system according to the embodiment is used;

FIG. 3 is a perspective view of an example of a fitting room in which a stationary information terminal of the commodity information providing system according to the embodiment is set;

FIG. 4 is a block diagram of an example of the stationary information terminal of the commodity information providing system according to the embodiment;

FIG. 5 is a block diagram of an example of a portable information terminal of the commodity information providing system according to the embodiment;

FIG. 6 is a block diagram of an example of a computer that operates as one of servers of the commodity information providing system according to the embodiment;

FIG. 7 is a block diagram of an example of a management terminal of the commodity information providing system according to the embodiment;

FIG. 8 is a block diagram of a configuration example of the commodity information providing system according to the embodiment;

FIG. 9 is a block diagram of another configuration example of the commodity information providing system according to the embodiment;

FIG. 10 is a schematic diagram of an example of a location specifying information database of the commodity information providing system according to the embodiment;

FIG. 11 is a schematic diagram of an example of a recommended commodity information database of the commodity information providing system according to the embodiment;

FIG. 12 is a schematic diagram of an example of a part of an account information database of the commodity information providing system according to the embodiment;

FIG. 13 is a schematic diagram of an example of a commodity-under-consideration information database of the commodity information providing system according to the embodiment;

FIG. 14 is a schematic diagram of an example of a prior registration information database of the commodity information providing system according to the embodiment;

FIG. 15 is a diagram of an example of a flowchart related to display of commodity information in the information terminal of the commodity information providing system according to the embodiment;

FIG. 16 is a diagram of an example of a display screen of the stationary information terminal of the commodity information providing system according to the embodiment;

FIG. 17 is a diagram of another example of the display screen of the stationary information terminal of the commodity information providing system according to the embodiment;

FIG. 18 is a diagram of still another embodiment of the display screen of the stationary information terminal of the commodity information providing system according to the embodiment;

FIG. 19 is a diagram of an example of a display screen of the portable information terminal of the commodity information providing system according to the embodiment;

FIG. 20 is a diagram of another example of the display screen of the portable information terminal of the commodity information providing system according to the embodiment;

FIG. 21 is a diagram of still another example of the display screen of the portable information terminal of the commodity information providing system according to the embodiment; and

FIG. 22 is a diagram of still another example of the display screen of the portable information terminal of the commodity information providing system according to the embodiment.

### DETAILED DESCRIPTION

In general, according to one embodiment, a commodity information providing system includes: a commodity-data acquiring section configured to acquire, on the basis of location data indicating a location of an information terminal including a display screen and commodity data associated with a place or an area, commodity data that is provided to or can be provided to the information terminal; and a display-data generating section configured to generate display data for displaying, on the display screen of the information terminal, information concerning a commodity corresponding to the commodity data acquired by the commodity-data acquiring section.

In this embodiment, a commodity information providing system 1 includes computers 3, information terminals 4, a management terminal 5, and a gate apparatus 6 electrically connected to one another via a wired or wireless communication line (e.g., the Internet) 2 or the like.

In the commodity information providing system 1, one or plural computers 3 can function as servers configured to provide a predetermined service. In the commodity information providing system 1, a service can be provided in a form of, for example, SaaS (Software as a Service).

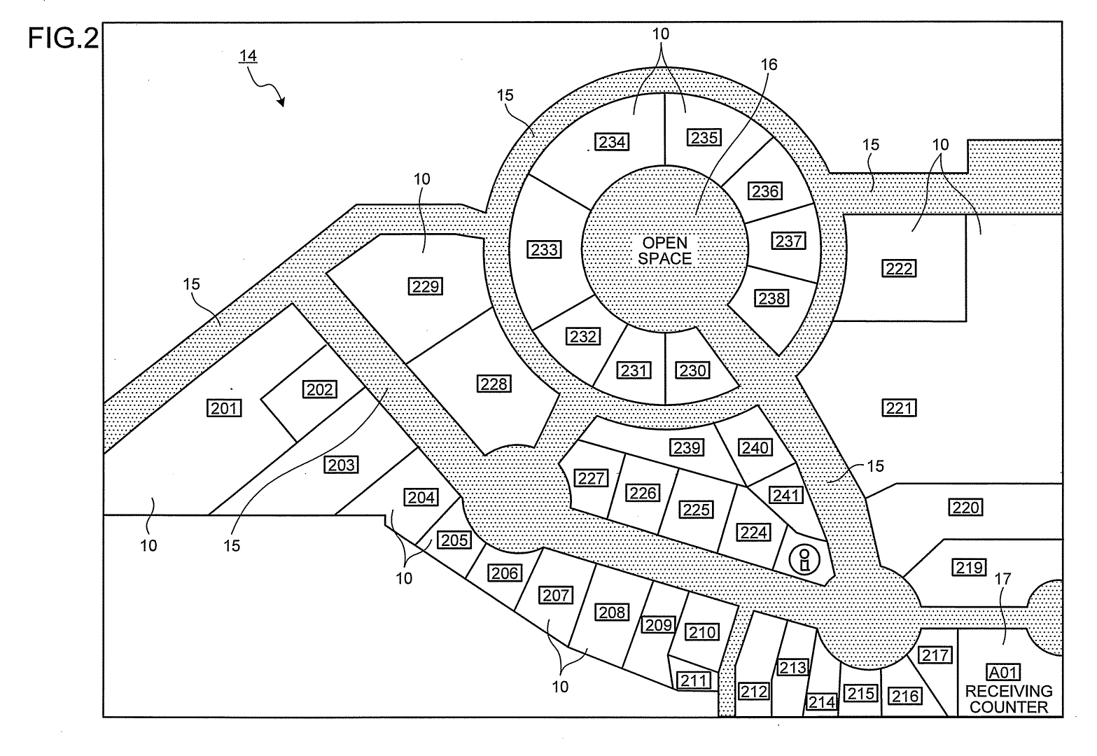

As the information terminals 4, for example, stationary information terminals 7 having a relatively large size, portable information terminals 8 carried by service users (hereinafter simply referred to as users) or the like, and portable information terminals 9 caned by the users or the like such as cellular phones, PDAs (Personal Digital Assistants), smartphones, and tablet PCs are used. It is suitable that setting locations of the stationary information terminals 7 can be changed as appropriate. As an example, the information terminals 8 are configured as apparatuses lent by a service provider, stores 10 (see FIG. 2), or the like as dedicated terminals with which a service can be easily used. All the information terminals 4 (7, 8, and 9) are configured as computers. General purpose or dedicated applications or the like for receiving a service are respectively installed in the information terminals 4.

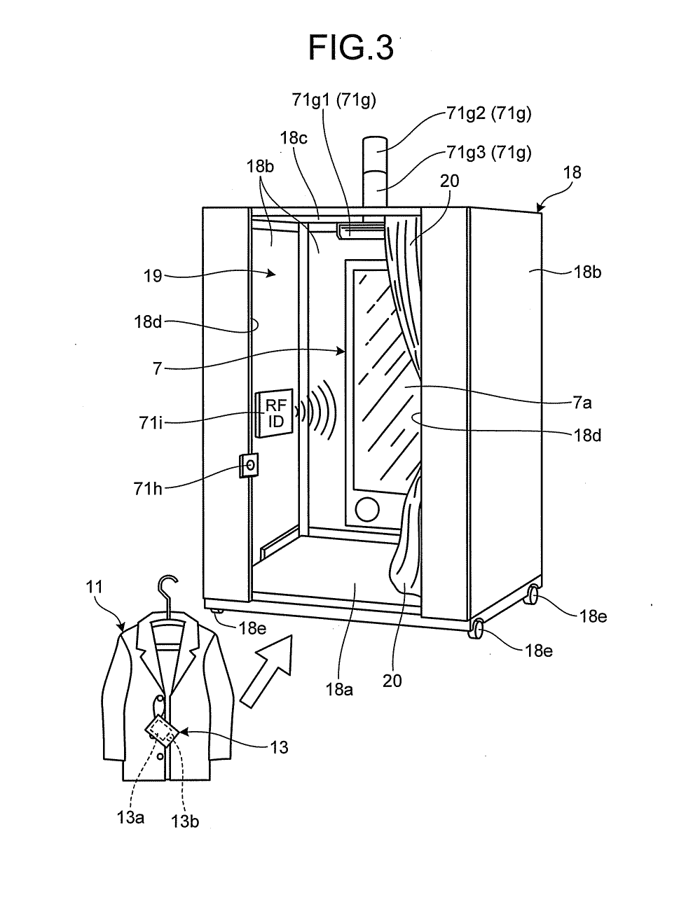

In the management terminal 5, an operator of the service provider (the stores 10, etc.), a user, or the like can perform management and procedures for sales, settlement, taking out home, and the like of a commodity 11 (see FIG. 3, etc.). As an example, the management terminal 5 can be configured as a POS (Point Of Sales) terminal.

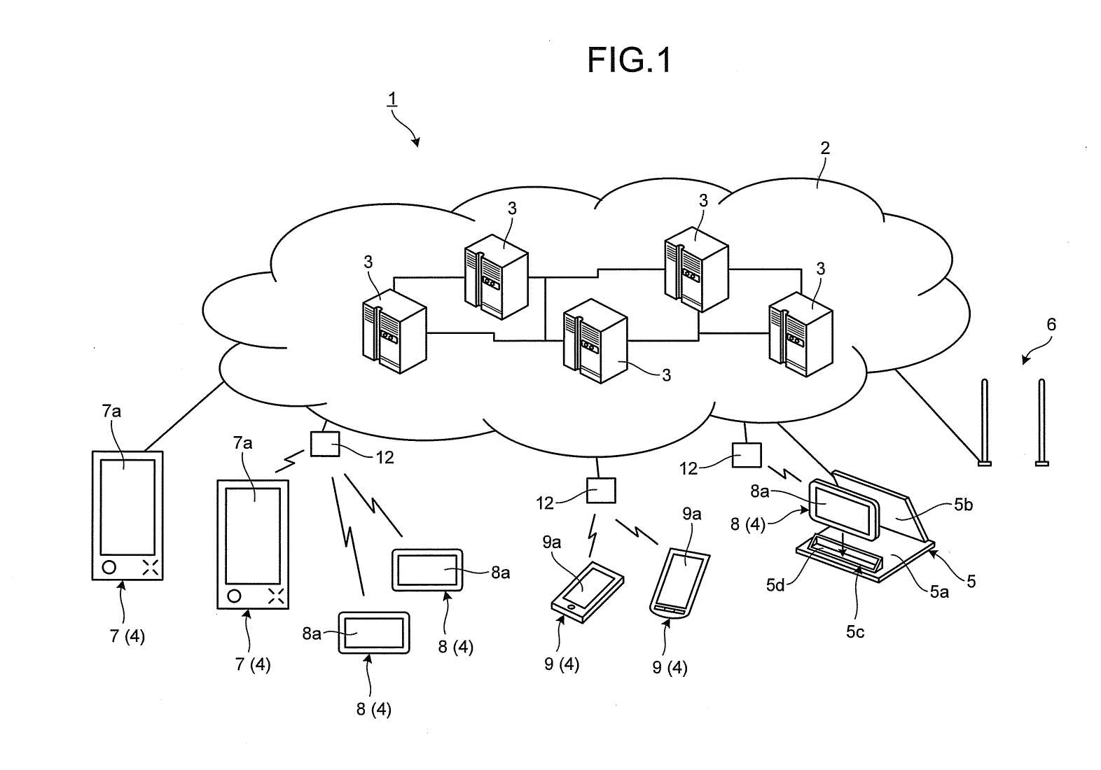

The management terminal 5 shown in FIG. 1 includes a base section 5a, a display section 5b including a display screen (not shown) provided on the base section 5a, and a dock 5c on which the information terminals 8 and 9 (in FIG. 1, as an example, the information terminals 8 are shown) can be placed. In the dock 5c, a connector (not shown) electrically connected to a connector (not shown) of the information terminal 8 is provided. If the information terminal 9 is used, communication by a predetermined wireless communication system is performed between a communication apparatus 12, which has a wireless communication area in a range including at least the dock 5c, and the information terminal 9. A movable cover 5d is provided in the dock 5c. The connectors of the management terminal 5 and the information terminal 8 are connected to each other in an inner part of the cover 5d in a state in which the cover 5d is opened. The information terminal 9 or the like is placed on a surface of the cover 5d in a state in which the cover 5d is closed. On the dock 5c, the information terminal 8 or 9 is set in a posture in which the display screen of the display section 5b of the management terminal 5 and a display screen 8a or 9a of the information terminal 8 or 9 are oriented in opposite directions. In other words, when the information terminal 8 or 9 is placed on the dock 5c, the display screen 8a or 9a of the information terminal 8 or 9 and the display screen of the display section 5b are oriented in the opposite directions. Therefore, in this embodiment, a face-to-face terminal where the operator of the service provider or the store 10 and the user who uses the service face each other is temporarily configured by the management terminal 5 and the information terminal 8 or 9.

The gate apparatus 6 is set in, for example, a place used as a gate such as a gateway of the store 10 or a shopping mall 14 (see FIG. 2). The gate apparatus 6 monitors entrance and exit of the commodity 11 (a tag 13 (see FIG. 3) affixed to the commodity 11) and the user (the portable information terminal 8 or 9, etc. carried by the user). The gate apparatus 6 can communicate with the commodity 11, the information terminal 8 or 9, and the like in a predetermined wireless communication system.

The communication apparatus 12 communicates with the information terminal 4, the management terminal 5, the gate apparatus 6, and the like in the predetermined wireless communication system (e.g., wireless LAN (Local Area Network)). The communication apparatus 12 is electrically connected to the communication line 2 by wire or radio.

The commodity information providing system 1 according to this embodiment is used in, for example, the shopping mall 14 shown in FIG. 2. In the shopping mall 14, plural stores 10 are arranged facing an aisle 15. An open space 16 and the like are also provided. A counter 17 where the user (a purchaser of the commodity 11) can receive the commodity 11 is provided in, for example, a location serving as a gate of the shopping mall 14 or a location easily accessed from the plural stores 10. In the commodity information providing system 1 according to this embodiment, if the information terminal 4 is located in the respective stores 10, information concerning the commodity 11 provided to the information terminal 4 is limited compared with information provided if the information terminal 4 is located in the aisle 15 and the open space 16 serving as common places or free spaces (areas indicated by dot patterns in FIG. 2).

The stationary information terminal 7 can be set in, for example, a fitting room (fitting booth, portable fitting booth) 18 shown in FIG. 3. In the fitting room 18, a room space 19 partitioned by a floor 18a, walls 18b, a ceiling 18c, and the like is formed. In an example shown in FIG. 3, the information terminal 7 including a vertical and rectangular display screen 7a having a relatively large size is set on the wall 18b on the back side. In an entrance 18d, a curtain 20 that can be opened and closed is set. The user can try on an actual object of the commodity 11 (clothing, etc.) in the room space 19 by closing the curtain 20 of the entrance 18d. The fitting room includes casters 18e with stoppers (not shown). The operator or the like of the service provider or the store 10 can move the fitting room 18 to a desired position and set the fitting room 18 in the desired position. The fitting room 18 can be set not only in the store 10 but also in the commonplace or the free space such as the aisle 15 or the open space 16. In the fitting room 18 set in the commonplace or the free space, sides (two lateral sides and a front side) excluding the back side where the information terminal 7 is set are covered with the curtain 20 to form the room space 19. In a state in which the curtain 20 is opened to show the inside of the fitting room 18 more widely, a virtual try-on image can be displayed on the display screen 7a. The stationary information terminal 7 can be used as a digital signage as well.

In the fitting room 18, an RFID (Radio Frequency IDentification) reader writer 71i is provided to face the inside of the room space 19. The RFID reader writer 71i performs wireless communication with the tag 13 affixed to the commodity 11 and receives commodity information stored in a storing section 13b from the tag 13 via an antenna 13a. In the fitting room 18, a sensor (e.g., an infrared sensor) 71h functioning as a human sensor is provided in the entrance 18d or the like. The sensor 71h detects the user, the operator, or the like who is present in the room space 19 or enters and exits the room space 19. Further, in the fitting room 18, a lamp 71g1 (71g) configured to illuminate the inside of the fitting room 18 and lamps 71g2 and 71g3 (71g) configure to inform the outside of predetermined events (e.g., use of the room space 19, call from the room space 19, and give an alarm of an invalid operation) are provided.

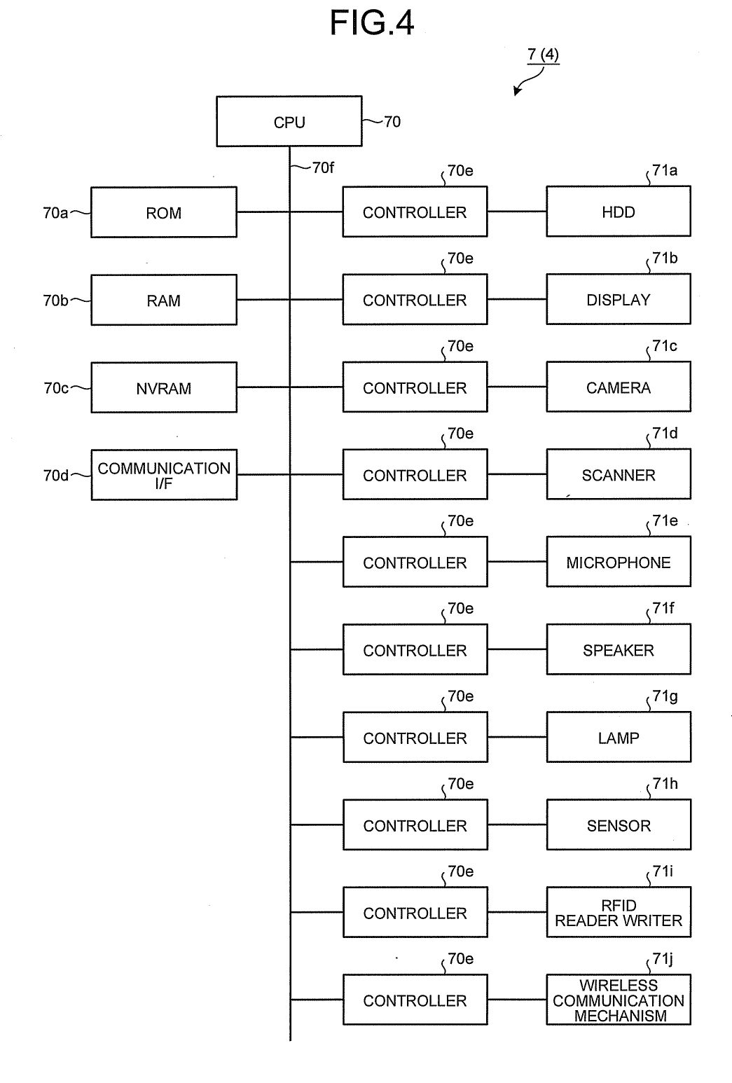

As shown in FIG. 4, the stationary information terminal 7 includes a CPU (Central Processing Unit) 70, a ROM (Read Only Memory) 70a, a RAM (Random Access Memory) 70b, an NVRAM (Non Volatile RAM) 70c, a communication interface (I/F) 70d, and controllers 70e for devices. These components are connected to one another via a bus 70f such as an address bus or a data bus. The information terminal 7 includes, as the devices, a hard disk drive (HDD) 71a, a display 71b, a camera 71c, a scanner 71d, a microphone 71e, a speaker 71f, the lamps 71g, the sensor 71h, the RFID reader writer 71i, and a wireless communication mechanism 71j. The information terminal 7 does not need to include all of the devices and only has to include the devices at least necessary for carrying out a service.

The CPU 70 executes various computer-readable programs stored in the ROM 70a or the like to thereby control the information terminal 7. The ROM 70a stores therein various data, various computer programs (a BIOS program, an application program, a device driver program, etc.), and the like executed by the CPU 70. When the CPU 70 executes the various computer programs, the RAM 70b temporarily stores the data and the computer programs. The NVRAM 70c is a nonvolatile rewritable memory. Data used in various arithmetic operations, processing, and the like are stored in the NVRAM 70c. The communication I/F 70d controls communication (exchange of data, etc.) between the information terminal 7 and another apparatus connected to the information terminal 7 via the communication line 2 or the like. The controller 70e receives a command of the CPU 70 to cause a device corresponding to the command to operate and sends an output of the corresponding device to the CPU 70.

The HDD 71a stores various data. The display 71b is configured as, for example, an LCD (Liquid Crystal Display) or an organic EL (Electro Luminescence) display. The display 71b is controlled by the CPU 70 and displays a predetermined image (a still image or a moving image).

The camera 71c picks up a moving image or a still image of the user in the room space (fitting space) 19. The image picked up by the camera 71c may either include or not include the commodity 11 tried on by the user.

The CPU 70 controls the display 71b to display a moving image picked up by the camera 71c on the display screen 7a of the information terminal 7 as a mirror image (a left-right reversed image) of a real image. Consequently, the user can use the display screen 7a as a mirror. Therefore, the CPU 70 can display an image of virtually try-on of the commodity 11, which is not actually tried on, on the display screen 7a by controlling the display 71b to display, on the display screen 7a, an image obtained by combining an image picked up by the camera 71c and an image of the commodity 11. Further, the CPU 70 can grasp an action of the user in the room space 19 on the basis of the image picked up by the camera 71c and recognize an instruction input of the user on the basis of the action. In this case, the CPU 70 controls the display 71b to display, on the display screen 7a, a cursor or the like corresponding to the action of the user. In other words, in this embodiment, the CPU 70 can realize a man-machine interface using the camera 71c and the display 71b.

The scanner 71d is, for example, a barcode scanner or an image scanner that can optically read a one-dimensional barcode or a two-dimensional barcode given to the tag 13 affixed to the commodity 11. For example, the scanner 71d is set in the fitting room 18 to face the inside of the room space 19.

The microphone 71e converts sound (voice) emitted by the user into an electric signal. The controller 70e corresponding to the microphone 71e sends the electric signal converted by the microphone 71e to the CPU 70. The speaker 71f converts the electric signal received from the CPU 70 via the controller 70e corresponding to the speaker 71f into sound and outputs the sound. The CPU 70 can analyze the electric signal from the microphone 71e and recognize an instruction input of the user. In this case, the CPU 70 controls the display 71b to display, on the display screen 7a, a cursor or the like corresponding to the sound of the user. In other words, in this embodiment, the CPU 70 can realize a man-machine interface using the microphone 71e and the display 71b.

The lamps 71g (71g1, 71g2, and 71g3, see FIG. 3) are controlled by the CPU 70 to be switched on and off. The lamp that illuminates the inside of the room space 19 may be switched on and off according to an operation of a not-shown switch. The controller 70e corresponding to the sensor 71h sends a detection result by the sensor 71h to the CPU 70. The RFID reader writer 71i executes wireless communication with an RFID tag of the tag 13 or the like affixed to the commodity 11. The wireless communication mechanism 71j exchanges data between the information terminal 7 and the communication apparatus 12 in the predetermined wireless communication system. The controller 70e corresponding to the wireless communication mechanism 71j sends data received from the communication apparatus 12 by the wireless communication mechanism 71j to the CPU 70 and sends data received from the CPU 70 to the communication apparatus 12 from the wireless communication mechanism 71j.

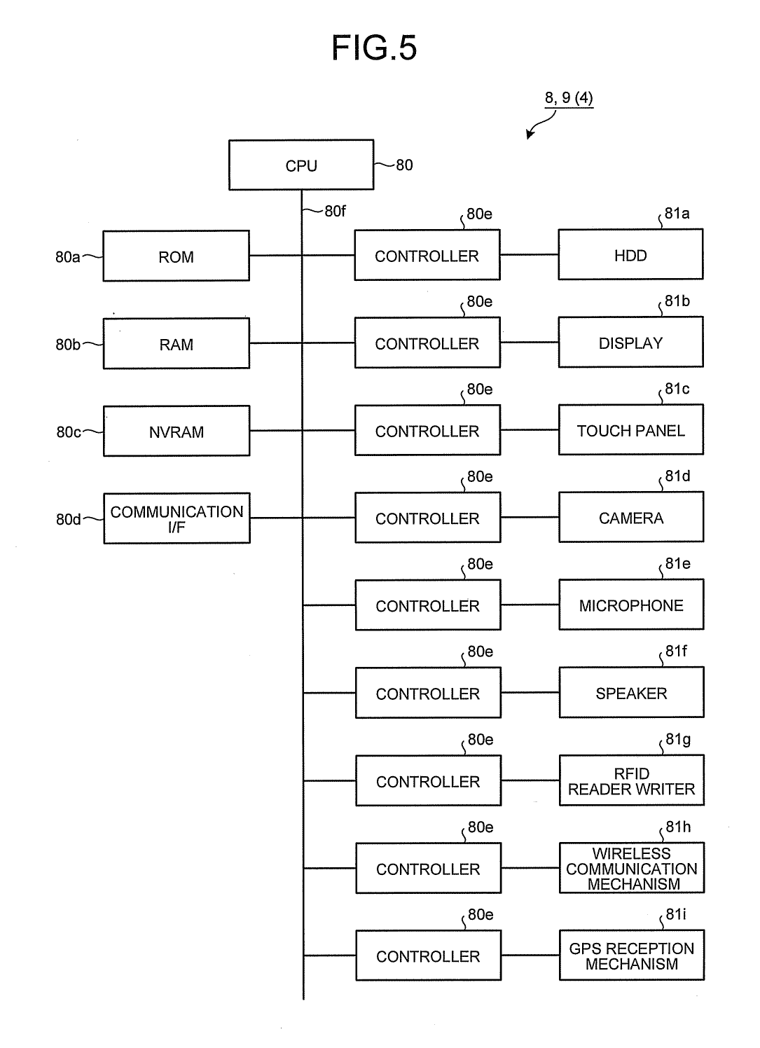

As shown in FIG. 5, the portable information terminal 8 or 9 includes a CPU (Central Processing Unit) 80, a ROM (Read Only Memory) 80a, a RAM (Random Access Memory) 80b, an NVRAM (Non Volatile RAM) 80c, a communication interface (I/F) 80d, and controllers 80e for devices. These components are connected to one another via a bus 80f such as an address bus or a data bus. The information terminal 8 or 9 includes, as the devices, a hard disk drive (HDD) 81a, a display 81b, a touch panel 81c, a camera 81d, a microphone 81e, a speaker 81f, an RFID reader writer 81g, a wireless communication mechanism 81h, and a GPS (Global Positioning System) reception mechanism 81i. The information terminal 8 or 9 does not need to include all of the devices and only has to include the devices at least necessary for carrying out a service. The basic configurations and operations of the CPU 80, the ROM 80a, the RAM 80b, the NVRAM 80c, the communication I/F 80d, the bus 80f, the controllers 80e, the HDD 81a, the display 81b, the camera 81d, the microphone 81e, the speaker 81f, the RFID reader writer 81g, the wireless communication mechanism 81h, and the like are the same as those of the information terminal 7. Therefore, redundant explanation of configurations and the operations is omitted.

The touch panel 81c detects a touch position on the display screen 8a or 9a by a finger of the user, a stylus, or the like. The controller 80e corresponding to the touch panel 81c sends a detection result to the CPU 80. The CPU 80 controls the display 81b to display, on the display screen 8a or 9a, a cursor or the like corresponding to an action of the finger of the user, the stylus, or the like. In other words, in this embodiment, the CPU 80 can realize a man-machine interface using the touch panel 81c and the display 81b. The information terminal 8 or 9 can include, as an operation input section, a keyboard, an operation button, a pointing device, or the like instead of the touch panel 81c or together with the touch panel 81c.

The GPS reception mechanism 81i receives a radio wave arriving from an artificial satellite. The CPU 80 can recognize the location (the latitude and the longitude) of the information terminal 8 or 9 from the radio wave received by the GPS reception mechanism 81i.

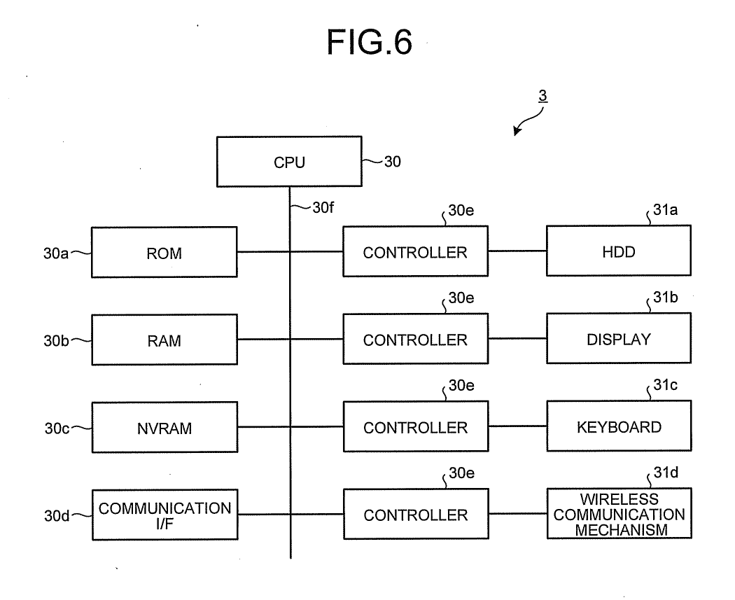

As shown in FIG. 6, the computer 3 operating as a server includes a CPU (Central Processing Unit) 30, a ROM (Read Only Memory) 30a, a RAM (Random Access Memory) 30b, an NVRAM (Non Volatile RAM) 30c, a communication interface (I/F) 30d, and controllers 30e for devices. These components are connected to one another via a bus 30f such as an address bus or a data bus. The computer 3 includes, as the devices, a hard disk drive (HDD) 31a, a display 31b, a keyboard 31c, and a wireless communication mechanism 31d. The computer 3 does not need to include all of the devices and only has to include the devices at least necessary for carrying out a service. The basic configurations and operations of the CPU 30, the ROM 30a, the RAM 30b, the NVRAM 30c, the communication I/F 30d, the bus 30f, the controllers 30e, the HDD 31a, the display 31b, the wireless communication mechanism 31d, and the like are the same as those of the information terminal 7. Therefore, redundant explanation of the configurations and the operations is omitted.

The controller 30e corresponding to the keyboard 31c sends an input signal of a key (not shown) to the CPU 30. The CPU 30 controls the display 31b to display, on a display screen (not shown) of the display 31b, a cursor or the like corresponding to an action of the operator or the like. In other words, in this embodiment, the CPU 30 can realize a man-machine interface using the keyboard 31c and the display 31b. The display 31b, the keyboard 31c, and the like are not used during provision of a normal service except some setting input or the like.

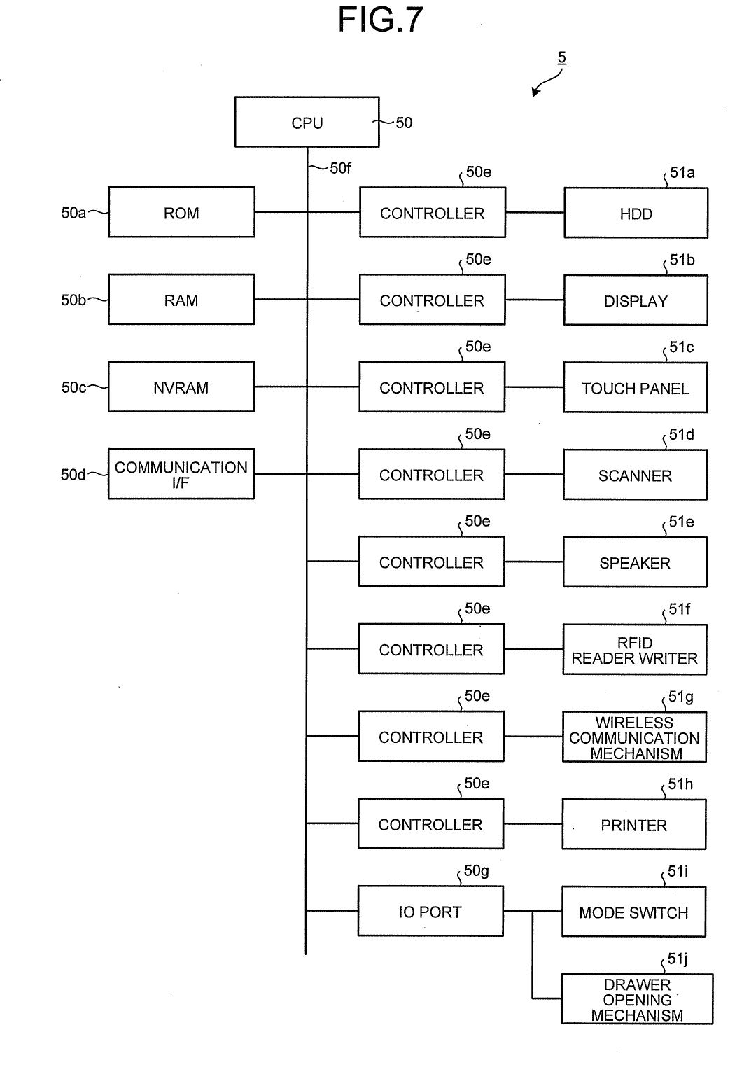

As shown in FIG. 7, the management terminal 5 operating as a POS terminal includes a CPU (Central Processing Unit) 50, a ROM (Read Only Memory) 50a, a RAM (Random Access Memory) 50b, an NVRAM (Non Volatile RAM) 50c, a communication interface (I/F) 50d, controllers 50e for devices, and an IO (Input/Output) port 50g. These components are connected to one another via a bus 50f such as an address bus or a data bus. The management terminal 5 includes, as the devices, a hard disk drive (HDD) 51a, a display 51b, a touch panel 51c, a scanner 51d, a speaker 51e, an RFID reader writer 51f, a wireless communication mechanism 51g, a printer 51h, a mode switch 51i, and a drawer opening mechanism 51j. The management terminal 5 does not need to include all of the devices and only has to include the devices at least necessary for carrying out a service. The basic configurations and operations of the CPU 50, the ROM 50a, the RAM 50b, the NVRAM 50c, the communication I/F 50d, the bus 50f, the controllers 50e, the HDD 51a, the display 51b, the touch panel 51c, the scanner 51d, the speaker 51e, the RFID reader writer 51f, the wireless communication mechanism 51g, and the like are the same as those of the information terminals 7 and 8. Therefore, redundant explanation of the configurations and the operations is omitted.

The printer 51h is controlled by the CPU 50 via the controller 50e corresponding to the printer 51h to perform printing on a sheet such as a receipt or a journal. The IO port 50g receives an input of a mode selection signal from the mode switch 51i and outputs the signal to the drawer opening mechanism 51j configured to automatically open a cash drawer of a drawer (not shown).

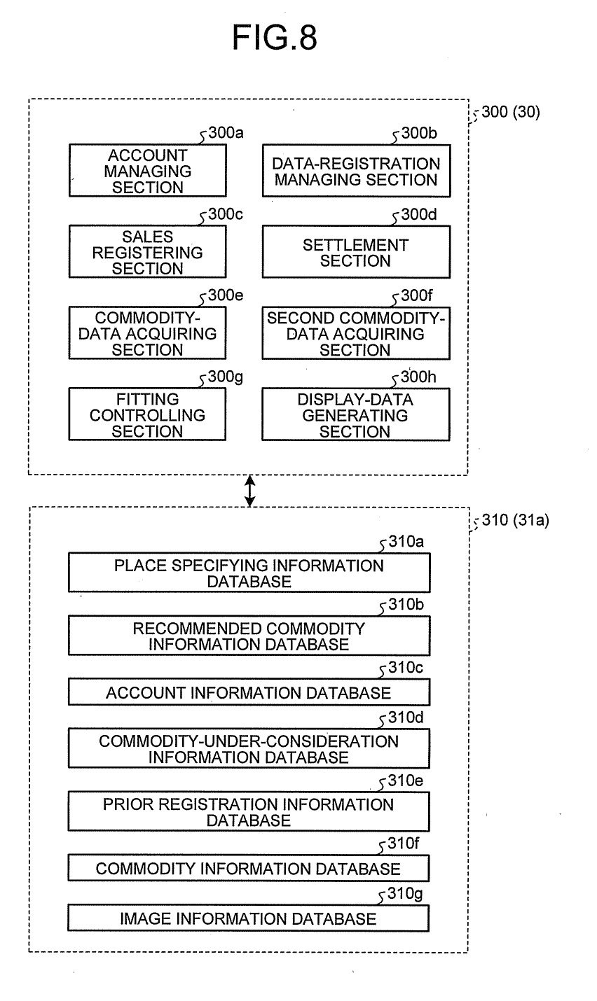

In the commodity information providing system 1 shown in FIG. 8, the CPU 30 of a server 300 including one computer operates as an account managing section 300a, a data-registration managing section 300b, a sales registering section 300c, a settlement section 300d, a commodity-data acquiring section 300e, a second commodity-data acquiring section 300f, a fitting controlling section 300g, a display-data generating section 300h, and the like. The operations of the sections are explained later. A computer program is installed in a storing section (e.g., the HDD 31a) of the computer 3. The CPU 30 operates according to the computer program read out from the storing section to thereby operates as the account managing section 300a, the data-registration managing section 300b, the sales registering section 300c, the settlement section 300d, the commodity-data acquiring section 300e, the second commodity-data acquiring section 300f, the fitting controlling section 300g, the display-data generating section 300h, and the like. In other words, the computer program includes modules respectively corresponding to the account managing section 300a, the data-registration managing section 300b, the sales registering section 300c, the settlement section 300d, the commodity-data acquiring section 300e, the second commodity-data acquiring section 300f, the fitting controlling section 300g, the display-data generating section 300h, and the like.

A storing section (e.g., one or plural HDDs 31a) 310 of the computer 3 operating as the server 300 or another computer 3 functions as a database. The storing section 310 functioning as the database is suitably configured as, for example, a RAID (Redundant Arrays of Inexpensive Disks). The storing section 310 includes a place specifying information database 310a, a recommended commodity information database 310b, an account information database 310c, a commodity-under-consideration information database 310d, a prior registration information database 310e, a commodity information database 310f, and an image information database 310g. The databases are explained later.

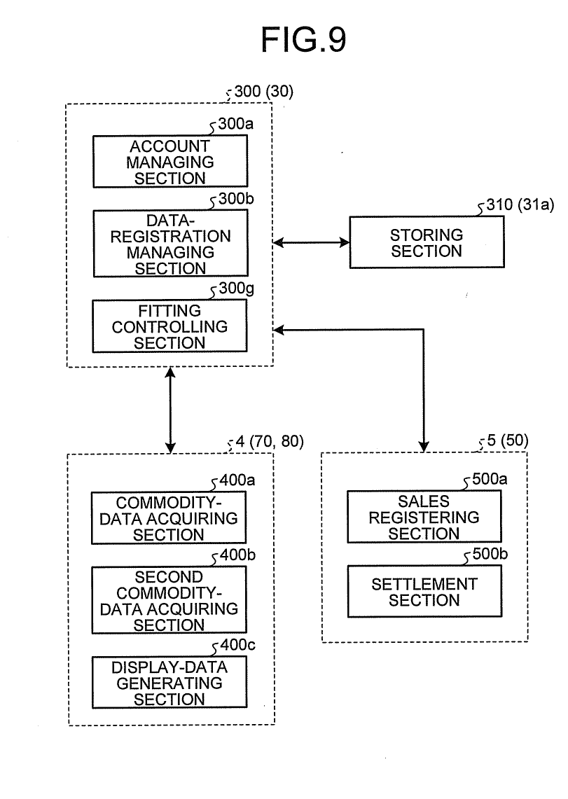

In the commodity information providing system 1 shown in FIG. 9 as an example different from the example shown in FIG. 8, the CPU 30 of the server 300 including one computer operates as the account managing section 300a, the data-registration managing section 300b, the fitting controlling section 300g, and the like. The CPU 70 or 80 of the information terminal 4 operates as a commodity-data acquiring section 400a, a second commodity-data acquiring section 400b, a display-data generating section 400c, and the like. The CPU 50 of the management terminal 5 operates as a sales registering section 500a, a settlement section 500b, and the like. The operations of the sections are explained later. A computer program is installed in the storing section (e.g., the HDD 31a) of the computer 3. The CPU 30 operates according to the computer program read out from the storing section to thereby operate as the account managing section 300a, the data-registration managing section 300b, the fitting controlling section 300g, and the like. A computer program is installed in a storing section (e.g., the HDD 71a or 81a) of the information terminal 4. The CPU 70 or 80 operates according to the computer program read out from the storing section to thereby operate as the commodity-data acquiring section 400a, the second commodity-data acquiring section 400b, and the display-data generating section 400c. A computer program is stored in a storing section (e.g., the HDD 51a) of the management terminal 5. The CPU 50 operates according to the computer program read out from the storing section to thereby operate as the sales registering section 500a, the settlement section 500b, and the like.

The account managing section 300a accesses the account information database 310c configured to stores an account ID and a password, compares the account ID and the password stored in the account information database 310c and an account ID and a password input in the information terminal 8, 9, or the like, and identifies whether an account is correct. According to addition of a new account, deletion of an account, change of a password, or the like, the account managing section 300a accesses the account information database 310c and executes addition, deletion, update, or the like of data.

The data-registration managing section 300b accesses the recommended commodity information database 310b configured to store, for example, commodity information of a recommended commodity 11 set for each store 10, the commodity-under-consideration information database 310d configured to store commodity information of the commodity 11 that the user considers to purchase or fit on (coordinate), the prior registration information database 310e configured to store commodity information of the commodity 11 that the user plans to purchase or take back home, and the like and executes addition, deletion, update, or the like of data.

The sales registering section 300c or 500a stores commodity information of the commodity 11, which the user purchases, in a predetermined storing section (e.g., the HDD 51a of the management terminal 5). The settlement section 300d or 500b executes settlement (settlement by cash, electronic money, a credit card, or the like) processing after registration processing is completed for the commodity 11 by the sales registering section 300c or 500a.

The commodity-data acquiring section 300e or 400a and the second commodity-data acquiring section 300f or 400b determine the commodity 11 (commodity data), commodity information of which is displayed on the display screen 7a, 8a, or 9a of the information terminal 4 (7, 8, or 9). The fitting controlling section 300g generates an image obtained by combining a person image and a commodity image or calculates parameters necessary for the combination. The display-data generating section 300h or 400c generates display data (e.g., XML (Extensible Markup Language) data) for displaying commodity information of the commodity 11 determined by the commodity-data acquiring section 300e or 400a or the second commodity-data acquiring section 300f or 400b on the display screen 7a, 8a, or 9a of the information terminal 4 (7, 8, or 9). In transmission and reception of various data among the computer 3, the information terminal 4, the management terminal 5, and the like, the CPUs 30, 70, 80, and 50 thereof operate as transmission and reception control sections (not shown).

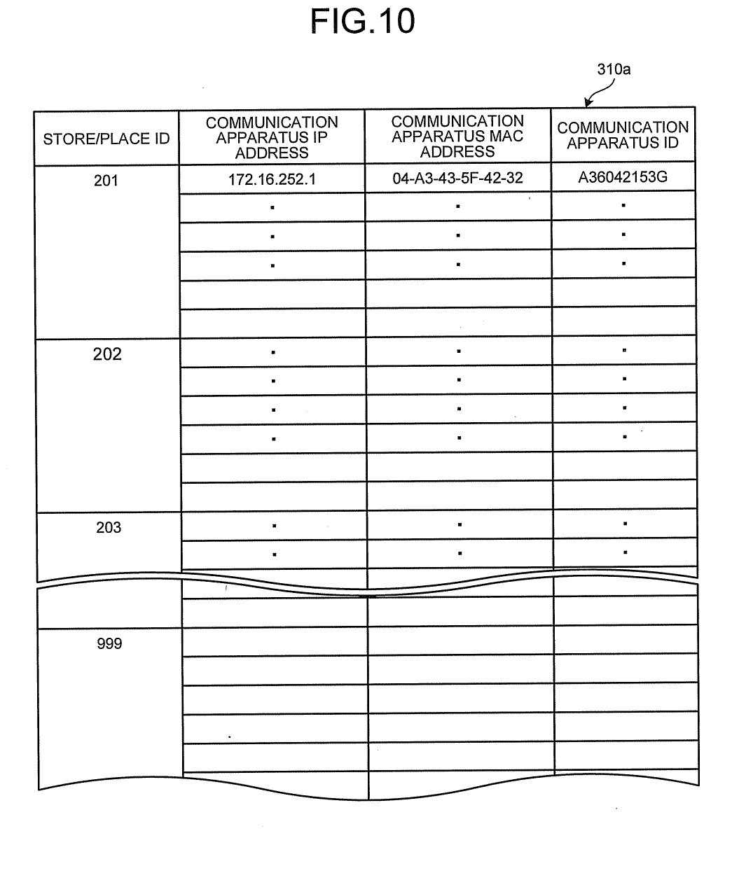

As shown in FIG. 10, in the place specifying information database 310a, an ID (a store or place ID) for specifying the store 10 or a place (the aisle 15, the open space 16, etc.) and information such as an IP address of a wired or wireless communication apparatus (e.g., the communication apparatus 12 or the gate apparatus 6), a MAC address of the communication apparatus, and an ID of the communication apparatus are stored in a state in which association between the store or place ID and the information is seen. If the place specifying information database 310a is referred to, it is possible to discriminate which store 10 or place a communication apparatus IP address, a communication apparatus MAC address, and a communication apparatus ID correspond to. Further, from these kinds of information (the communication apparatus IP address, the communication apparatus MAC address, and the communication apparatus ID) concerning the communication apparatus that is performing communication with the information terminal 4, it is possible to discriminate in which store 10 or place the information terminal 4 is located. Specifically, in this embodiment, a store or place ID, an IP address of a communication apparatus, a MAC address of the communication apparatus, an ID of the communication apparatus, and the like of the place specifying information database 310a are equivalent to first information corresponding to a location of presence of the information terminal 4 (indicating the location of presence). If the information terminal 4 includes the GPS reception mechanism 81i (see FIG. 5), data of the latitude and the longitude of the information terminal 4 or a store or place ID obtained by comparing and referring to the data of the latitude and the longitude and data of the latitude and the longitude of the store 10 or the place (the aisle 15, the open space 16, etc.) could be the first information.

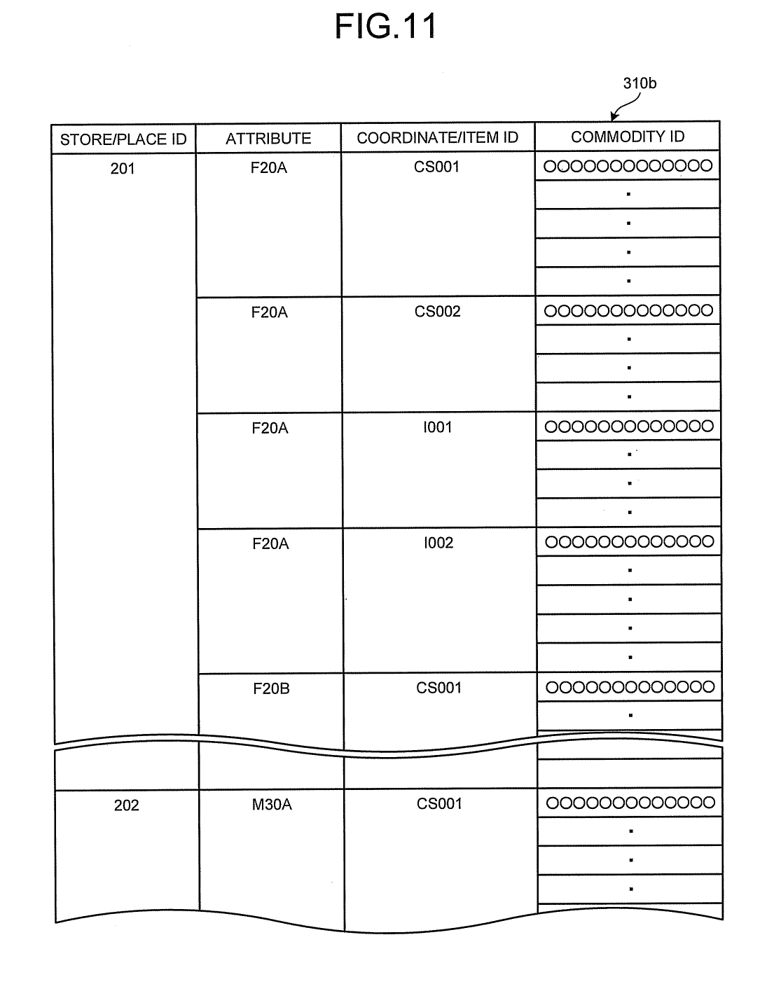

As shown in FIG. 11, in the recommended commodity information database 310b, an ID (a store or place ID) for identifying the store 10 or a place, an attribute of a user, an ID of coordinates or an item, and a commodity ID (a commodity code) are stored in a state in which association among the IDs and the attribute is seen. Plural commodity IDs and one attribute correspond to the ID of coordinates or an item. A coordinate ID (e.g., CS001 or CS002) distinguishes a combination (coordinates) of plural items such as clothing (e.g., a jacket, a shirt, a blouse, pants, shoes, and a bag). Therefore, commodity IDs of plural items are associated with one coordinate ID. An item ID (e.g., 1001 or 1002) distinguishes a type of an item (e.g., any one of a jacket, a shirt, a blouse, pants, shoes, and a bag). Therefore, commodity IDs of plural different commodities 11 of the same type are associated with one item ID. An attribute of a user is associated with each of combinations of the coordinates or the items. The attribute of a user distinguishes sex, age, taste, and the like of the user. For example, “F” of “F20A” indicates female, “20” indicates age (twenties), and “A” indicates that a user is oriented to casual wears. For example, “M” of “M30A” indicates male and “B” of “F20B” indicates that a user is oriented to formal wears. For each store 10, plural coordinate and item IDs are set. The recommended commodity information database 310b is information indicating the store 10 or a place where commodity information of the commodity 11 is provided. Therefore, in this embodiment, the store or place ID included in the recommended commodity information database 310b is equivalent to second information corresponding to a providing place of commodity information (indicating the providing place).

In this embodiment, the place specifying information database 310a and the recommended commodity information database 310b can be referred to as information for associating the first information and the second information (information indicating association of the first information and the second information).

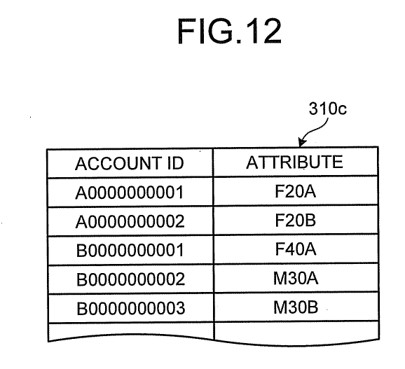

As shown in FIG. 12, an account ID and an attribute are stored in a part of the account information database 310c in a state in which association between the account ID and the attribute is seen. From the account information database 310c, sex, age, taste, and the like of each user are seen.

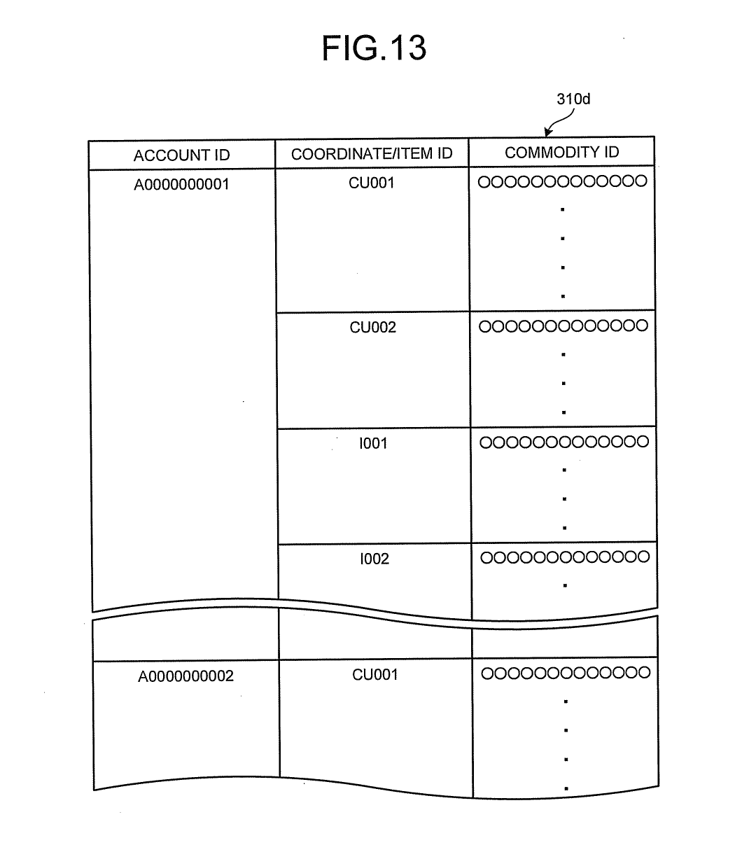

As shown in FIG. 13, an account ID, a coordinate or item ID, and a commodity ID are stored in the commodity-under-consideration information database 310d in a state in which association among the IDs are seen. Coordinates or an item determined by a user is stored in the commodity-under-consideration information database 310d. The user can operate the information terminal 4 and display coordinates or an item (a group of commodities) on the display screen 7a, 8a, or 9a. The user can store information (an ID, etc.) of a commodity or a coordinated group of commodities in a database in association with an account ID from an external terminal (a personal computer, etc.) via a telecommunication line such as the Internet before going out to the store 10 or the shopping mall 14.

In this embodiment, the place specifying information database 310a and the commodity-under-consideration information database 310d can be referred to as information for associating the first information and third information corresponding to a providing place of commodity information of the commodity 11 selected by the user (information indicating association of the first information and the third information).

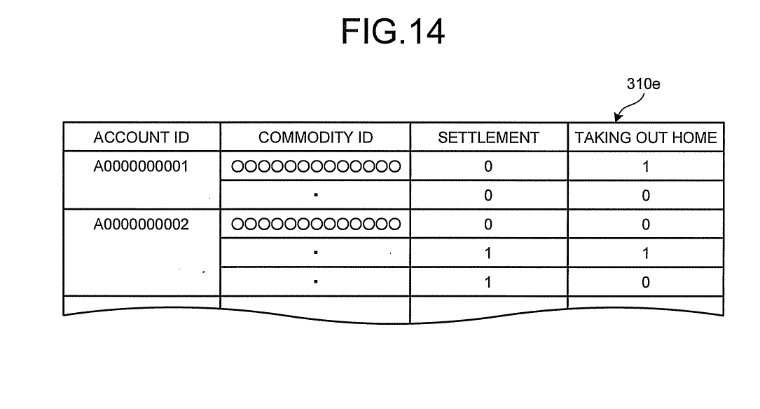

As shown in FIG. 14, in the prior registration information database 310e, a commodity ID of the commodity 11 registered beforehand by the user is stored for each account ID. A flag indicating presence or absence of settlement (settled or unsettled) and a flag indicating presence or absence of taking back home of the commodity 11 (whether the commodity 11 is taken out to the outside from a management area of the store 10 or the shopping mall 14) are stored for each commodity 11. For example, the flag indicating presence or absence of settlement is set to “1” to indicate settled and set to “0” to indicate unsettled. For example, the flag indicating presence or absence of taking back home is set to “1” to indicate that the commodity 11 is brought back home and set to “0” to indicate that the commodity 11 is not brought back home.

In the commodity information database 310f (see FIG. 8), specifications (a commodity name, a brand name, a store name, a price, a size, a color, etc.) are stored in association with a commodity ID (a commodity code) of the commodity 11. In the image information database 310g (see FIG. 8), various images such as a commodity image of the commodity 11, an image of combined (coordinated) commodities 11 (a coordinate image), and a person image are stored. The image information database 310g includes information registered by the service provider and information registered by the user.

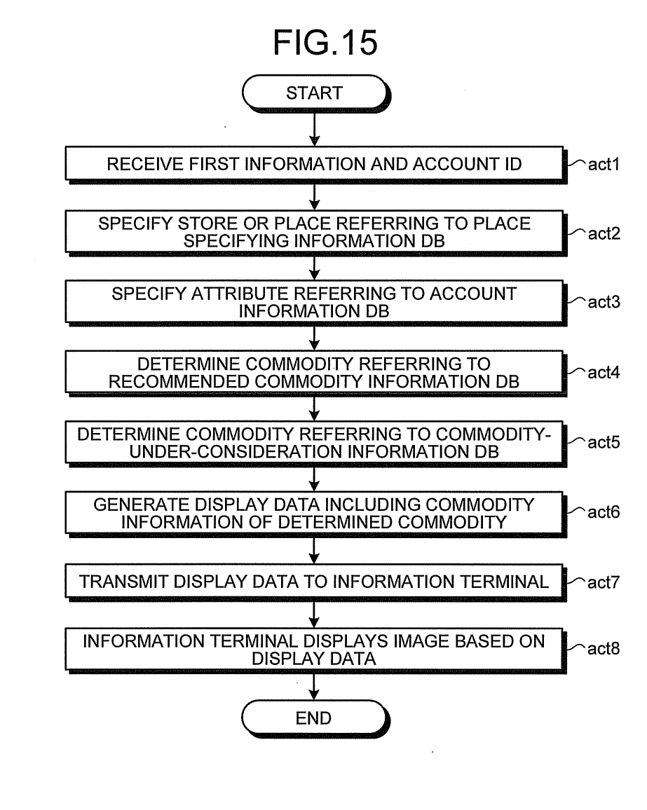

FIG. 15 is a flowchart for explaining an example of a process for displaying commodity information of the commodity 11 on the information terminal 4 in the commodity information providing system 1. First, the commodity-data acquiring section 300e or 400a receives first information corresponding to a location of presence of the information terminal 4 from the information terminal 4 or a communication apparatus (e.g., the communication apparatus 12 or the gate apparatus 6) communicating with the information terminal 4 and receives an account ID of a user logging in to the information terminal 4 (Act 1).

Subsequently, the commodity-data acquiring section 300e or 400a obtains, referring to the place specifying information database (DB) 310a, a store or place ID corresponding to the received first information (Act 2).

The commodity-data acquiring section 300e or 400a obtains, referring to the account information database 310c, an attribute corresponding to the received account ID (Act 3).

The commodity-data acquiring section 300e or 400a obtains, referring to the recommended commodity information database 310b, a commodity ID, a coordinate ID, or an item ID corresponding to the store or place ID obtained in Act 2 and the attribute obtained in Act 3 (Act 4). In Act 4, the commodity 11 (commodity data), commodity information of which is provided by the information terminal 4, is determined.

On the other hand, at least after Act 1, the second commodity-data acquiring section 300f or 400b obtains, referring to the commodity-under-consideration information database 310d, a commodity ID, a coordinate ID, or an item ID corresponding to the account ID (Act 5). In Act 5, as in Act 4, the commodity 11 (commodity data), commodity information of which is provided by the information terminal 4, is determined. Act 5 only has to be performed after Act 1 and may be performed before Acts 2 to 4.

The display-data generating section 300h or 400c generates display data (e.g., XML data) in the information terminal 4 including the commodity information of the commodity 11 determined in at least one of Acts 4 and 5 (Act 6). The commodity information of the commodity 11 provided by the information terminal 4 is, for example, an image (e.g., a photograph image or an illustration) and specifications (e.g., a brand name, a store name, a size, a price, a color, and a quantity of stock) of the commodity 11.

Subsequently, (the transmission and reception control section) of the server 300 transmits the display data generated by the display-data generating section 300h or 400c to the information terminal 4 (Act 7). Consequently, an image obtained from the display data, i.e., an image including the commodity information of the commodity 11 determined in at least one of Acts 4 and 5 is displayed on the display screen 7a, 8a, or 9a of the information terminal 4 (Act 8). In the case of the configuration shown in FIG. 9, transmission and reception of display data between the apparatuses is not performed. However, the commodity information and the image of the commodity 11 determined in Acts 4 and 5 and stored in the commodity information database 310f and the image information database 310g of the storing section 310 are transmitted to the information terminal 4.

In the flow shown in FIG. 15, the commodity 11 (the commodity data) acquired by the commodity-data acquiring section 300e or 400a in Act 4 is the commodity 11 provided by the service provider (e.g., the store 10, a group of stores 10, the shopping mall 14, a brand, or a shopping street). In this embodiment, commodity information of the recommended commodity 11 is provided. However, commodity information does not need to be the commodity information of the recommended commodity 11 and may be, for example, commodity information of the commodity 11 sold in a large quantity, the commodity 11 just put on the market, or the like. On the other hand, the commodity 11 (the commodity data) acquired by the second commodity-data acquiring section 300f or 400b in Act 5 is the commodity 11 selected by the user who registers the account. In short, this embodiment has a characteristic in that, concerning the commodity 11 provided by the service provider, a place where the commodity information is provided by the information terminal 4 is limited (set in advance) and, concerning the commodity 11 selected by the user, a place where the commodity information is provided by the information terminal 4 is not limited.

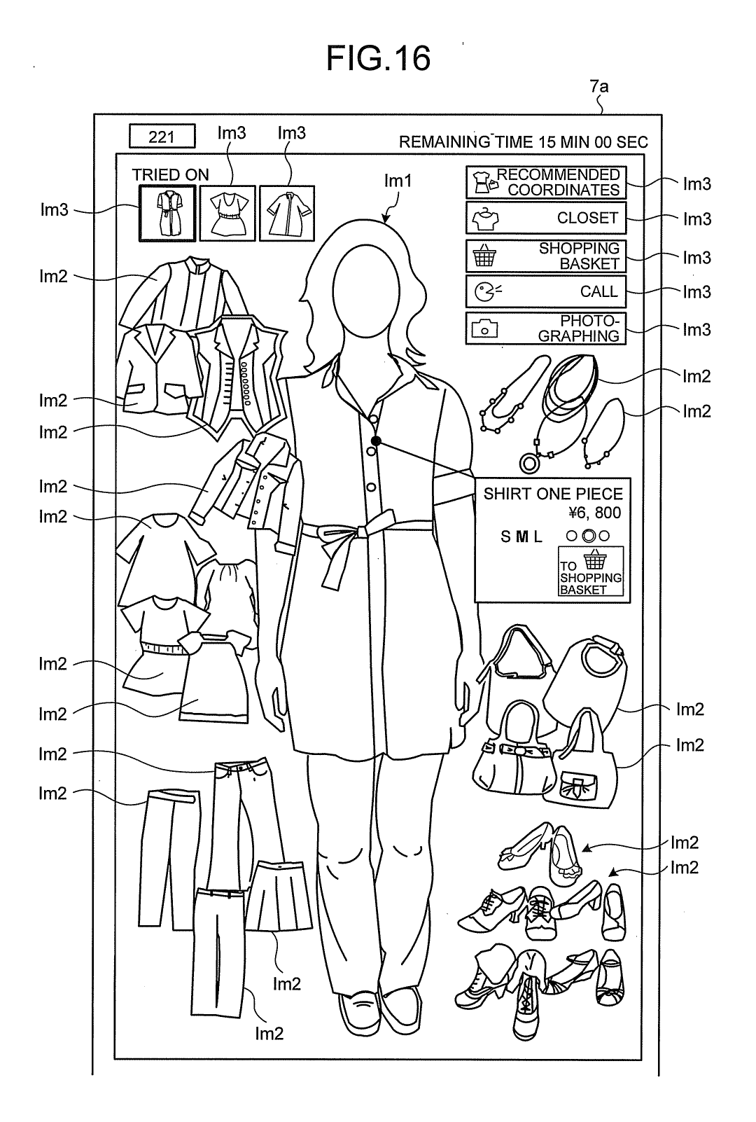

FIGS. 16 to 18 are diagrams of examples of images displayed on the display screen 7a of the stationary information terminal 7. A person image Im1, which is a mirror image of an image picked up by the camera 71c, is displayed in the center of the display screen 7a. The person image Im1 may be a moving image, which moves according to the movement of an actual object, may be a still image, or may be an image picked up beforehand or on the spot.

As shown in FIG. 16, plural commodity images Im2 are displayed as commodity information around the person image Im1. The commodity images Im2 are displayed while being reduced or simplified as appropriate according to the size and the aspect ratio of the display screen 7a, the size of the person image Im1, and the like. In the example shown in FIG. 16, the plural commodity images Im2 are displayed while being collected for each type of an item (a jacket, a one-piece dress, pants, a necklace, a bag, shoes, etc.).

In the example shown in FIG. 16, icon images Im3 for operation are displayed. The user performs predetermined operation, moves a cursor, highlighting, or the like, selects the icon image Im3, and performs predetermined operation for deciding and executing the selection. Then, the CPU 30 or 70 performs operation corresponding to the icon image Im3. For example, if the user performs predetermined operation to thereby drag the commodity image Im2 onto the icon image Im3 of “closet” on the display screen 7a, the data-registration managing section 300b registers the commodity 11 (a commodity ID) of the selected commodity image Im2 in the commodity-under-consideration information database 310d.

For example, if the user performs predetermined operation to thereby drag the commodity image Im2 onto the icon image Im3 of “shopping basket” on the display screen 7a, the data-registration managing section 300b registers the commodity 11 (a commodity ID) of the selected commodity image Im2 in the prior registration information database 310e.

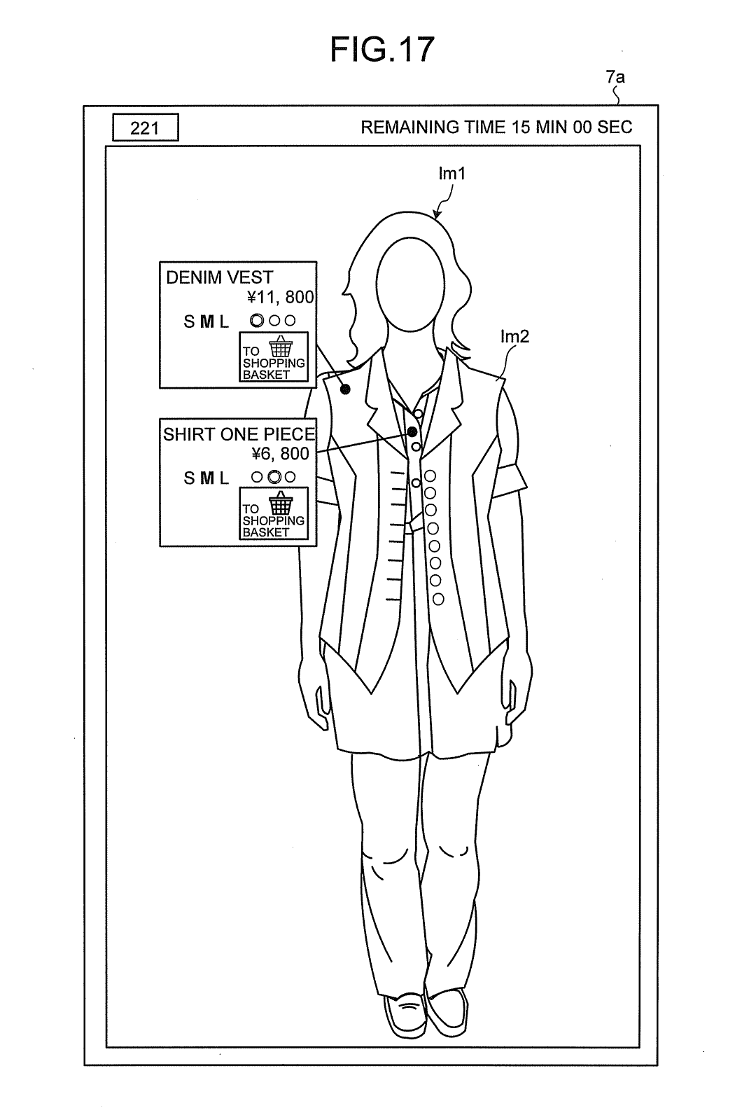

For example, if the user performs predetermined operation to thereby drag the commodity image Im2 onto the person image Im1 on the display screen 7a, as shown in FIG. 17, the fitting controlling section 300g forms an image in which a person in the person image Im1 virtually wears the commodity 11 of the commodity image Im2. The image is displayed on the display screen 7a.

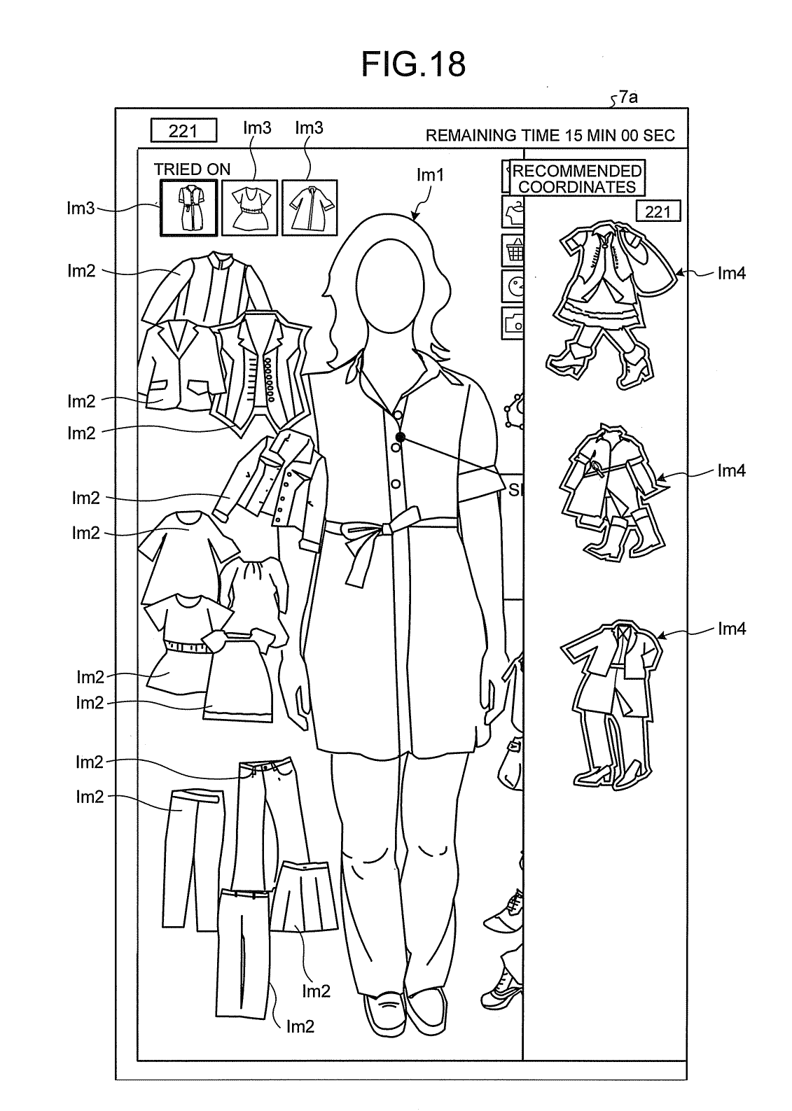

For example, if the user performs predetermined operation to thereby select and execute the icon image Im3 of “recommended coordinates” on the display screen 7a, as shown in FIG. 18, coordinate images Im4 of the commodities 11 are displayed on the basis of display data generated by the display-data generating section 300h. In this example, the coordinate images Im4 displayed according to the selection of “recommended coordinate” is equivalent to commodity information provided by the service provider.

As explained above, in this embodiment, propriety of display on the display screen 7a of the commodity information provided by the service provider is different depending on a location of presence of the information terminal 7. If the information terminal 7 is set in the store 10, commodity information (e.g., an image and character information) of the commodity 11 corresponding to the store 10 (associated with a store ID) is displayed on the display screen 7a of the information terminal 7. Commodity information of the commodity 11 not corresponding to the store 10 is not displayed. However, commodity information (e.g., an image and character information) of the commodity 11 associated with a logged-in account ID is displayed on the display screen 7a irrespective of the location of the information terminal 7, i.e., even if the commodity information is commodity information of the commodity 11 (of, for example, another store 10) not associated with the store 10. Although not shown in the figure, commodity information registered by the user is expanded (displayed) on the display screen 7a if the user performs predetermined operation for selecting and determining the icon image Im3 of “closet” on the display screen 7a shown in FIG. 16.

On the other hand, in this embodiment, if the information terminal 7 is set in a common place or a free space such as the aisle 15 or the open space 16, limitation on display on the display screen 7a of commodity information provided by the service provider is relaxed compared with limitation applied if the information terminal 7 is located in the store 10. Specifically, all kinds of commodity information (commodity information associated with other one or more places and areas) of the commodities 11 of the registered stores 10 (e.g., all the stores 10 in the shopping mall 14) can be displayed. Alternatively, depending on a setting location, commodity information (commodity information associated with other one or more places and areas) of the commodities 11 of the plural stores 10 around the setting location can be displayed. In this embodiment, a range in which commodity information is provided can be set (changed) as appropriate according to association of a commodity ID, a coordinate ID, an item ID, and a store or place ID, i.e., association of the commodity information with second information corresponding to a providing place of the commodity information (indicating the providing place) in the recommended commodity information database (a commodity information database of commodities provided by the service provider) 310b.

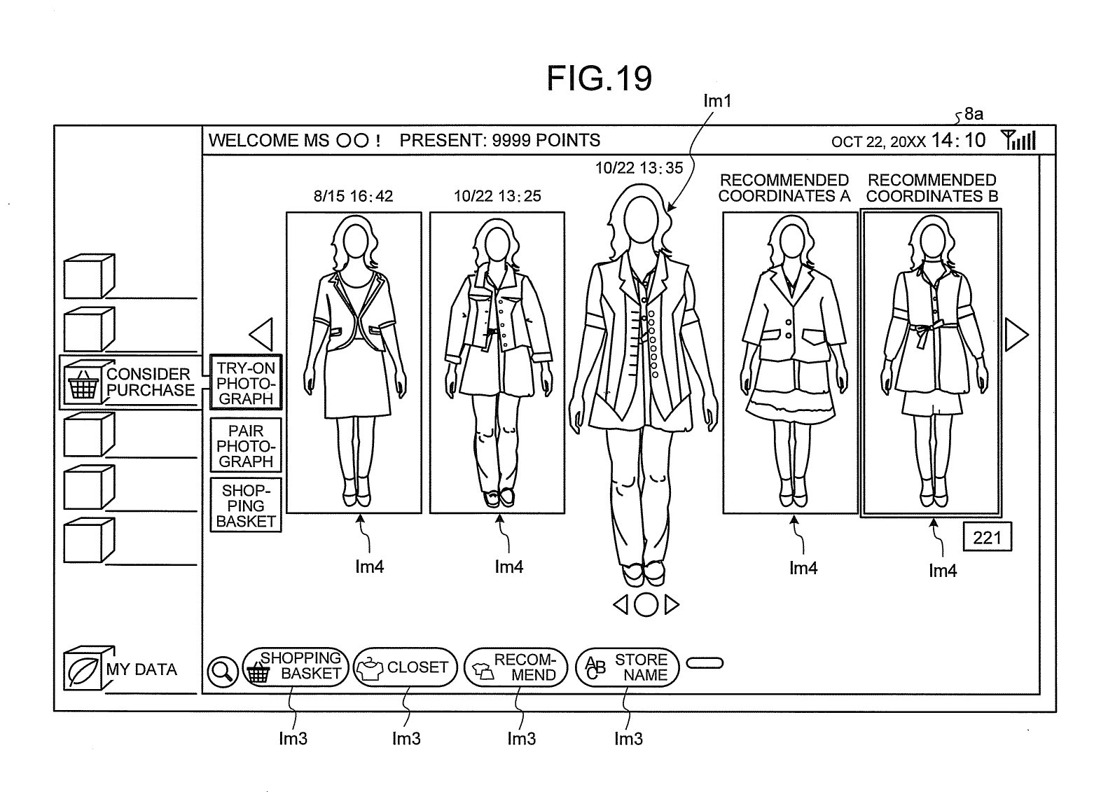

FIGS. 19 to 22 are diagrams of examples of images displayed on the display screen 8a of the portable information terminal 8. The person image Im1 is displayed in the center of the display screen 8a. As an example, a mirror image of an image picked up by the camera 71c of the stationary information terminal 7 can be used as the person image Im1.

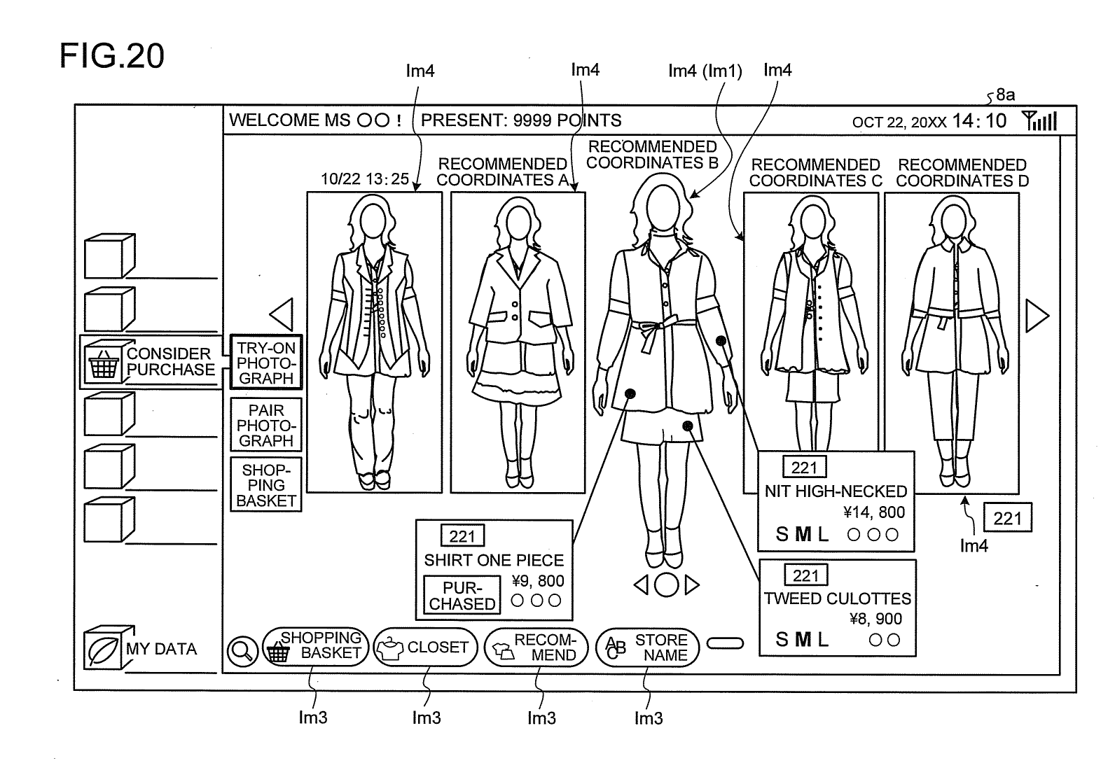

As shown in FIG. 19, the plural coordinate images Im4 are displayed as commodity information around the person image Im1. The coordinate images Im4 are displayed while being reduced or simplified as appropriate according to the size and the aspect ratio of the display screen 8a, the size of the person image Im1, and the like. In the example shown in FIG. 19, the coordinate images Im4 provided from the service provider and the coordinate images Im4 registered by the user in advance through, for example, operation in the stationary information terminal 7 are displayed on the display screen 8a. The user performs predetermined operation, selects “recommended coordinates B” on the display screen 8a, and performs predetermined operation for deciding and executing the selection. Then, as shown in FIG. 20, the CPU 30 or 70 uses the coordinate image Im4 of “recommended coordinates B” as the person image Im1.

In the example shown in FIG. 19, the icon images Im3 for operation are displayed. The user performs predetermined operation, moves a cursor, highlighting, or the like on the display screen 8a, selects the icon image Im3, and performs predetermined operation for deciding and executing the selection. Then, the CPU 30 or 70 performs operation corresponding to the icon image Im3. For example, if the user performs predetermined operation to thereby drag the coordinate image Im4 of “recommended coordinates B” onto the icon image Im3 of “closet” on the display screen 8a, the data-registration managing section 300b registers the commodities 11 (commodity IDs or a coordinate ID) of the selected coordinate image Im4 in the commodity-under-consideration information database 310d. For example, if the user performs predetermined operation to thereby drag the coordinate image Im4 onto the icon image Im3 of “shopping basket” on the display screen 8a, the data-registration managing section 300b registers the commodities 11 (commodity IDs) of the selected coordinate image Im4 in the prior registration information database 310e.

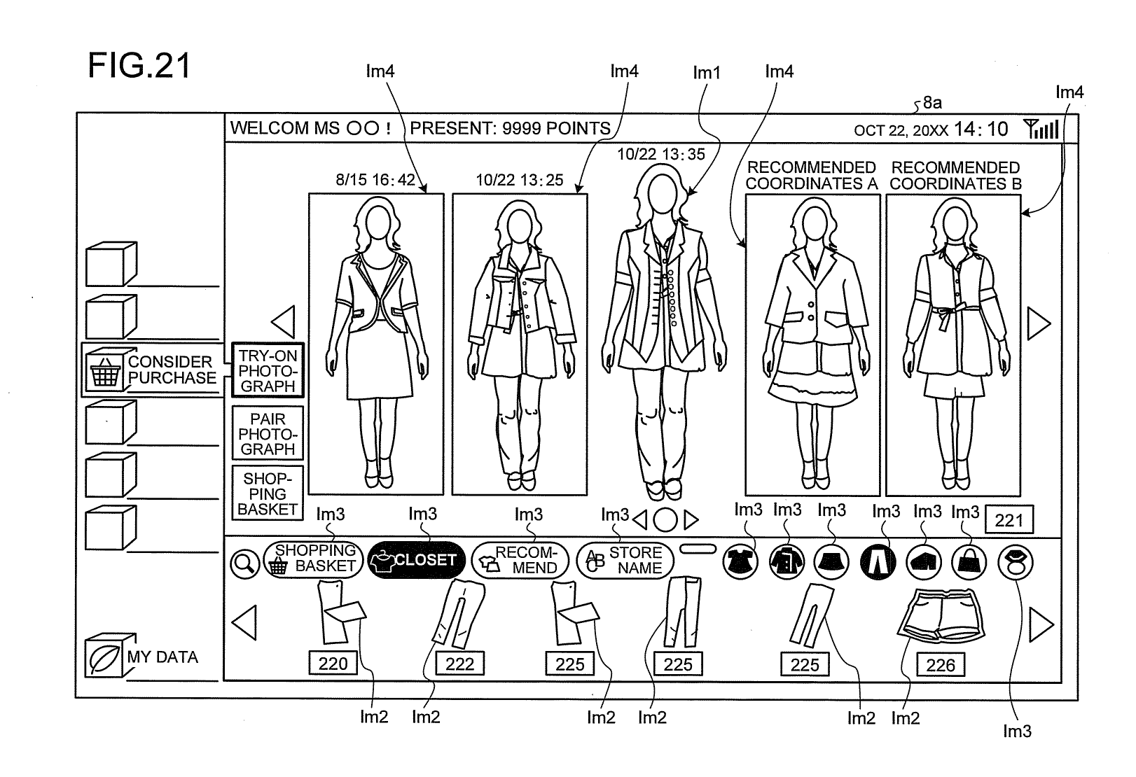

For example, if the user performs predetermined operation to thereby select and execute the icon image Im3 of “closet” on the display screen 8a, as shown in FIG. 21, the commodity images Im2 of the commodities 11 registered by the user beforehand for consideration are displayed on the basis of display data generated by the display-data generating section 300h.

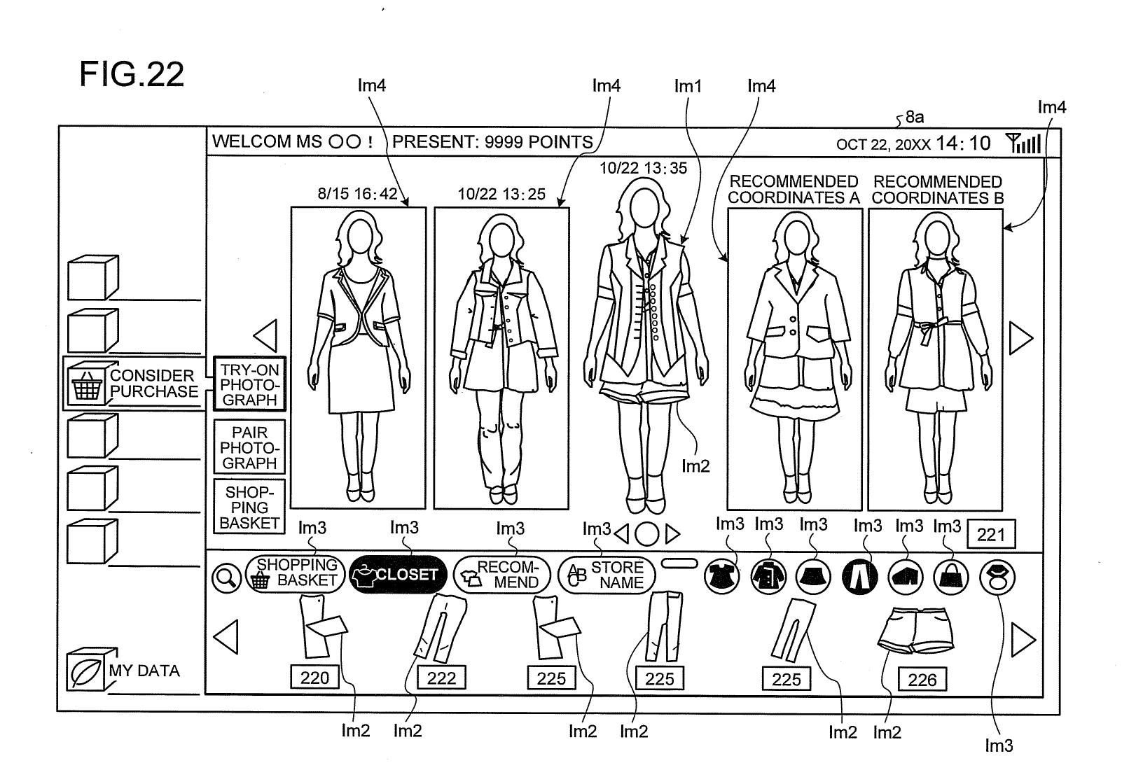

Further, for example, if the user performs predetermined operation to thereby drag the commodity image Im2 onto the person image Im1 on the display screen 8a, as shown in FIG. 22, the fitting controlling section 300g forms an image in which a person in the person image Im1 virtually wears the commodity 11 of the commodity image Im2. The image is displayed on the display screen 8a.

As explained above, in this embodiment, propriety of display on the display screen 8a of the commodity information provided by the service provider is different depending on a location of presence of the information terminal 8. If the information terminal 8 is located in the store 10, commodity information (e.g., an image and character information) of the commodity 11 corresponding to the store 10 (associated with a store ID) is displayed on the display screen 8a of the information terminal 8. Commodity information of the commodity 11 not corresponding to the store 10 is not displayed. However, commodity information (e.g., an image and character information) of the commodity 11 associated with a logged-in account ID is displayed on the display screen 8a irrespective of the location of the information terminal 8, i.e., even if the commodity information is commodity information of the commodity 11 (of, for example, another store 10) not associated with the store 10.

On the other hand, in this embodiment, if the information terminal 8 is located in a common place of a free space such as the aisle 15 or the open space 16, limitation on display on the display screen 8a of commodity information provided by the service provider is relaxed compared with limitation applied if the information terminal 8 is located in the store 10. Specifically, all kinds of commodity information of the commodities 11 of the registered stores 10 (e.g., all the stores 10 in the shopping mall 14) can be displayed. Alternatively, depending on a location of presence, commodity information of the commodities 11 of the plural stores 10 around the location of presence can be displayed. In this embodiment, a range in which commodity information is provided can be set (changed) as appropriate according to association of a commodity ID, a coordinate ID, an item ID, and a store or place ID, i.e., association of the commodity information with second information corresponding to a providing place of the commodity information (indicating the providing place) in the recommended commodity information database (a commodity information database of commodities provided by the service provider) 310b. The operations and the effects of the information terminal 8 are the same concerning the information terminal 9.

The embodiment is explained above. However, the present invention is not limited to the embodiment and various modifications of the embodiment are possible. For example, the commodity-data acquiring section can determine commodity data that can be provided by the information terminal. For example, the information terminal can determine commodity information of which commodity data is specifically displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity information providing system comprising:
a commodity-data acquiring section configured to acquire, on the basis of location data indicating a location of an information terminal including a display screen and commodity data associated with a place or an area, commodity data that is provided to or can be provided to the information terminal; and
a display-data generating section configured to generate display data for displaying, on the display screen of the information terminal, information concerning a commodity corresponding to the commodity data acquired by the commodity-data acquiring section.

2. The system according to claim 1, wherein, if the location data corresponds to a specific place or area, the commodity-data acquiring section acquires commodity data associated with another place or area as the commodity data that is provided to or can be provided to the information terminal.

3. The system according to claim 2, wherein, if the location data corresponds to the specific place or area, the commodity-data acquiring section acquires plural commodity data associated with other plural places or areas as the commodity data that is provided to or can be provided to the information terminal.

4. The system according to claim 1, further comprising a second commodity-data acquiring section configured to acquire, irrespective of the place or area, commodity data stored in a storing section in association with a specific ID as the commodity data that is provided to or can be provided to the information terminal, wherein
the display-data generating section generates display data for displaying, on the display screen of the information terminal, information concerning a commodity corresponding to the commodity data acquired by the second commodity-data acquiring section.

5. The system according to claim 4, wherein the display-data generating section generates display data for displaying, on the display screen of the information terminal, an image obtained by combining the commodity corresponding to the commodity data acquired by the commodity-data acquiring section and the commodity corresponding to the commodity data acquired by the second commodity-data acquiring section.

6. A commodity information providing method comprising:
acquiring, on the basis of location data indicating a location of an information terminal including a display screen and commodity data associated with a place or an area, commodity data that is provided to or can be provided to the information terminal; and
generating display data for displaying, on the display screen of the information terminal, information concerning a commodity corresponding to the commodity data acquired in the acquiring commodity data that is provided to or can be provided to the information terminal.

7. The method according to claim 6, wherein the acquiring commodity data includes acquiring, if the location data corresponds to a specific place or area, commodity data associated with another place or area as the commodity data that is provided to or can be provided to the information terminal.

8. The method according to claim 7, wherein the acquiring commodity data includes acquiring, if the location data corresponds to the specific place or area, plural commodity data associated with other plural places or areas as the commodity data that is provided to or can be provided to the information terminal.

9. The method according to claim 6, further comprising acquiring, irrespective of the place or area, commodity data stored in a storing section in association with a specific ID as the commodity data that is provided to or can be provided to the information terminal, wherein
the generating display data includes generating display data for displaying, on the display screen of the information terminal, information concerning a commodity corresponding to the commodity data acquired in the acquiring commodity data stored in the storing section.

10. The method according to claim 9, wherein the generating display data includes generating display data for displaying, on the display screen of the information terminal, an image obtained by combining the commodity corresponding to the commodity data acquired in the acquiring commodity data that is provided to or can be provided to the information terminal and the commodity corresponding to the commodity data acquired in the acquiring commodity data stored in the storing section.
